(19) United States
(12) Patent Application Publication
(10) Pub. No.: US 2025/0218667 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Kun Hoi KOO, Suwon-si (KR); Pum San CHAE, Suwon-si (KR); Sang Won CHOI, Suwon-si (KR); Ho Jae LEE, Suwon-si (KR)

(73) Assignee: SAMSUNG ELECTRO-MECHANICS CO., LTD., Suwon-si (KR)

(21) Appl. No.: 18/949,013

(22) Filed: Nov. 15, 2024

(30) Foreign Application Priority Data
Dec. 27, 2023 (KR) 10-2023-0193518

(51) Int. Cl. H01G 4/012; H01G 4/12; H01G 4/30

(52) U.S. Cl. CPC H01G 4/012; H01G 4/30; H01G 4/1227

(57) ABSTRACT

A multilayer electronic component of the present disclosure may allow an electric field formed in a first direction between an internal electrode layer and a floating electrode layer to also be formed in a second direction or a third direction, which may offset the stress formed in a stress concentration region, thereby improving the reliability, including the breakdown voltage (BDV) characteristics, of the laminated electronic component.

CROSS-REFERENCE TO RELATED APPLICATION(S)

This application claims benefit of priority to Korean Patent Application No. 10-2023-0193518 filed on Dec. 27, 2023, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic product, such as image display devices including a liquid crystal display (LCD) and a plasma display panel (PDP), computers, smartphones and mobile phones, an on-board charger (OBC) of an electric vehicle, and circuits such as DC-DC converter, and serves to charge or electricity therein or discharge electricity therefrom.

When voltage is applied to a multilayer ceramic capacitor, stress may occur inside the multilayer ceramic capacitor due to an electrostriction phenomenon of a dielectric layer, which may cause a decrease in the reliability, including the breakdown voltage (BDV) characteristics, of the multilayer ceramic capacitor.

Conventionally, attempts have been made to alleviate the electrostriction phenomenon, such as introducing a floating electrode layer structure.

However, although the internal electrode structure introducing a general floating electrode layer may achieve an effect of alleviating the concentration of stress to some extent by entirely distributing a voltage, stress due to electrostriction may concentrate on corners in which electrode patterns of different polarities overlap each other in a stacking direction of the internal electrodes. Accordingly, even when introducing a floating electrode layer, BDV characteristics or reliability may be deteriorated, and this phenomenon may be further aggravated when operating the multilayer ceramic capacitor at high voltage.

Accordingly, in the internal electrode structure introducing the floating electrode layer, structural improvement is needed to alleviate a phenomenon of stress concentration due to electrostriction in the corners in which the electrode patterns of different polarities overlap each other in the stacking direction of the internal electrode.

### SUMMARY

An aspect of the present disclosure is to alleviate the phenomenon of stress concentration due to electrostriction at corners in which electrode patterns of different polarities overlap each other in a stacking direction of an internal electrode, in an internal electrode structure introducing a floating electrode layer.

However, the aspects of the present disclosure are not limited to the above-described contents, and may be more easily understood in the process of describing specific embodiments of the present disclosure.

A multilayer electronic component according to some example embodiments of the present disclosure may include: a body including a dielectric layer, and an internal electrode layer and a floating electrode layer alternately arranged in a first direction with the dielectric layer interposed therebetween, and including a first surface and a second surface opposing each other in the first direction, a third surface and a fourth surface connected to the first surface and the second surface and opposing each other in a second direction, and a fifth surface and a sixth surface connected to the first surface to the fourth surface and opposing each other in a third direction; and external electrodes disposed on each of the third surface and the fourth surface, and the internal electrode layer may include a first electrode pattern connected to the third surface, and a second electrode pattern spaced apart from the first electrode pattern in the third direction and connected to the fourth surface, and the floating electrode layer may include a third electrode pattern spaced apart from the third surface and the fourth surface, a fourth electrode pattern spaced apart from the third electrode pattern and connected to the third surface, and a fifth electrode pattern spaced apart from the third electrode pattern and connected to the fourth surface.

A multilayer electronic component according to another example embodiments of the present disclosure may include: a body including a dielectric layer, and an internal electrode layer and a floating electrode layer alternately arranged in a first direction with the dielectric layer interposed therebetween, and including a first surface and a second surface opposing each other in the first direction, a third surface and a fourth surface connected to the first surface and the second surface and opposing each other in a second direction, and a fifth surface and a sixth surface connected to the first surface to the fourth surface and opposing each other in a third direction; and an external electrode respectively disposed on the third surface and the fourth surface, and the internal electrode layer may include a first electrode pattern connected to the third surface, and a second electrode pattern spaced apart from the first electrode pattern in the third direction and connected to the fourth surface, the floating electrode layer may include a third electrode pattern spaced apart from the third surface and the fourth surface, the first electrode pattern may include a first connection portion in contact with the external electrode on the third surface, and a first body portion that extends from the first connection portion in the second direction but is longer in the second direction and narrower in the third direction than the first connection portion, and the second electrode pattern may include a second connection portion in contact with the external electrode on the fourth surface, and a second body portion that extends from the second connection portion in the second direction but is longer in the second direction and narrower in the third direction than the second connection portion.

One of the various effects of the present disclosure is to improve the reliability, including the BDV characteristics, of a multilayer electronic component by controlling a shape of electrode patterns included in an internal electrode layer and a floating electrode layer and relieving the stress concentrating on corners in which electrode patterns of different polarities overlap each other in a stacking direction of the internal electrodes, in a multilayer electronic component including an internal electrode layer and a floating electrode layer,

Advantages and effects of the present disclosure are not limited to the foregoing content and may be more easily understood in the process of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure and another example embodiment of the present disclosure;

FIG. 2 is a cross-sectional view taken along line I-I′ of FIG. 1;

FIG. 3 is a cross-sectional view taken along line II-II′ of FIG. 1;

FIG. 4 is a cross-sectional view taken along line III-III′ of FIG. 1;

FIG. 5A illustrates a region of an electrode pattern in which electrostriction stress is concentrated in a multilayer electronic component according to a comparative example, and FIG. 5B illustrates a region of an electrode pattern in which electrostriction stress is concentrated in a multilayer electronic component according to an inventive example;

FIG. 6A schematically illustrates a plan view of an internal electrode layer according to an example embodiment, and FIG. 6B schematically illustrates a plan view of a floating electrode layer according to an example embodiment; and

FIG. 7 schematically illustrates an exploded perspective view of a body according to an embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, the contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a thickness T direction, a second direction may be defined as a length L direction, and a third direction may be defined as a width W direction.

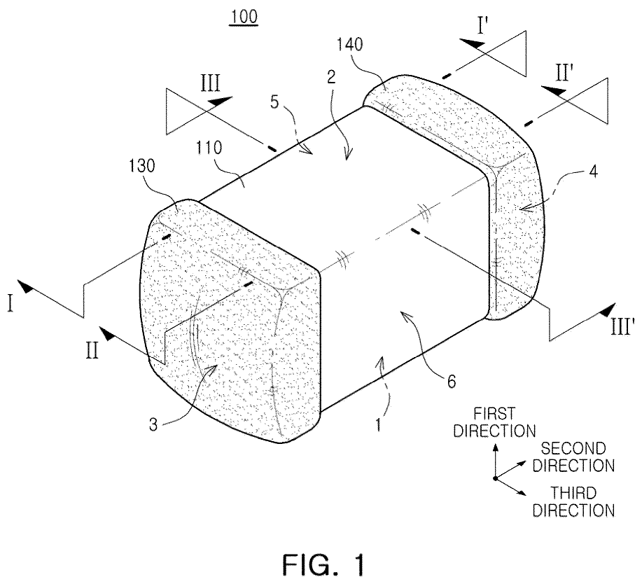

FIG. 1 is a perspective view schematically illustrating a multilayer electronic component according to an example embodiment of the present disclosure and another example embodiment of the present disclosure;

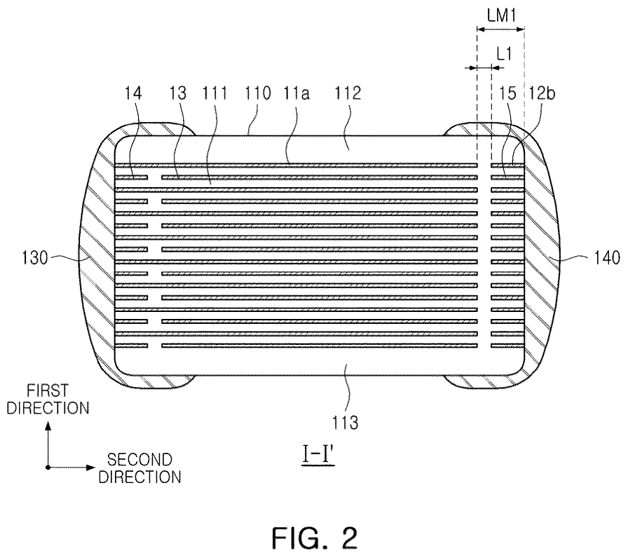

FIG. 2 is a cross-sectional view taken along line I-I′ of FIG. 1;

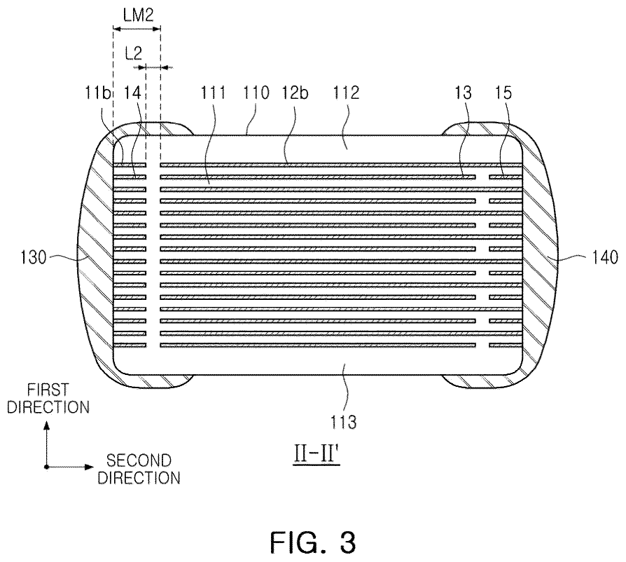

FIG. 3 is a cross-sectional view taken along line II-II′ of FIG. 1;

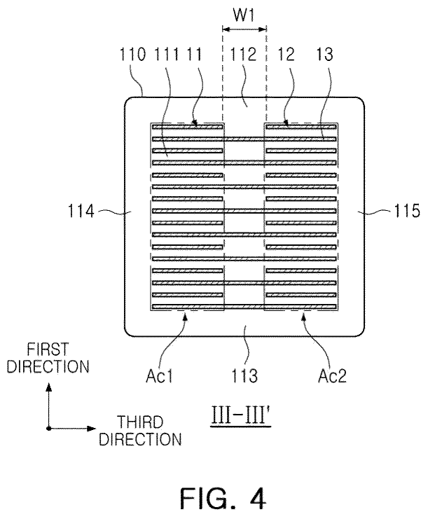

FIG. 4 is a cross-sectional view taken along line III-III′ of FIG. 1;

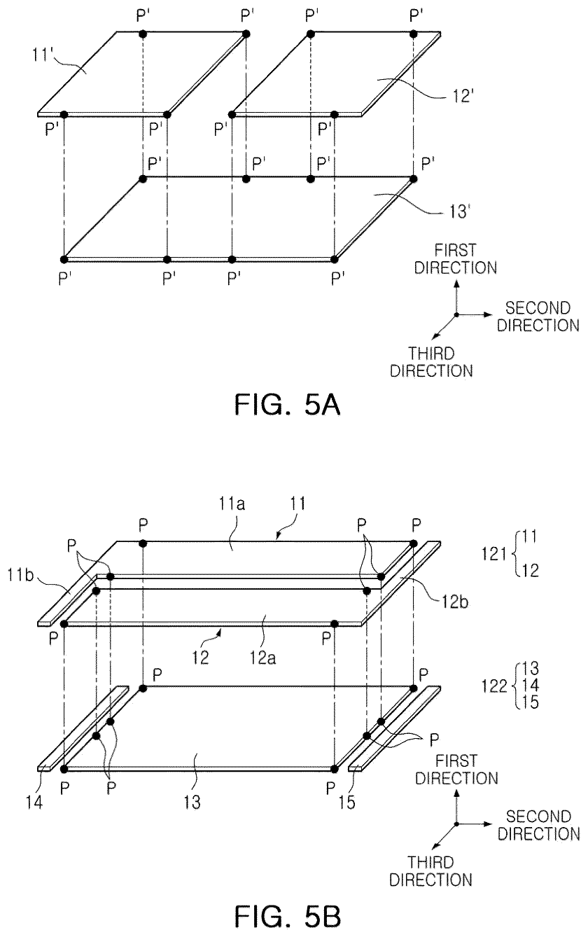

FIG. 5A illustrates a region of an electrode pattern in which electrostriction stress is concentrated in a multilayer electronic component according to a comparative example, and FIG. 5B illustrates a region of an electrode pattern in which electrostriction stress is concentrated in a multilayer electronic component according to an inventive example;

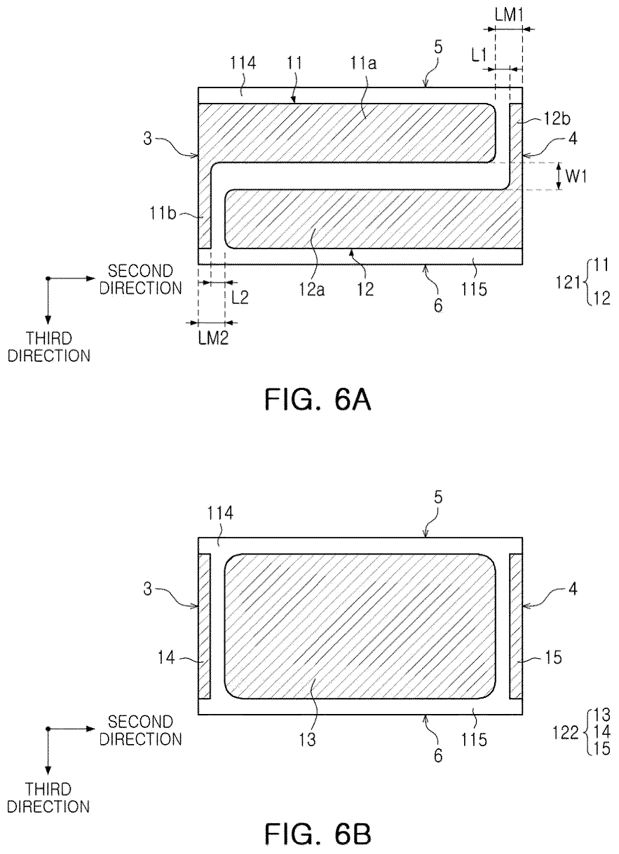

FIG. 6A schematically illustrates a plan view of an internal electrode layer according to some example embodiments, and FIG. 6B schematically illustrates a plan view of a floating electrode layer according to example embodiments; and

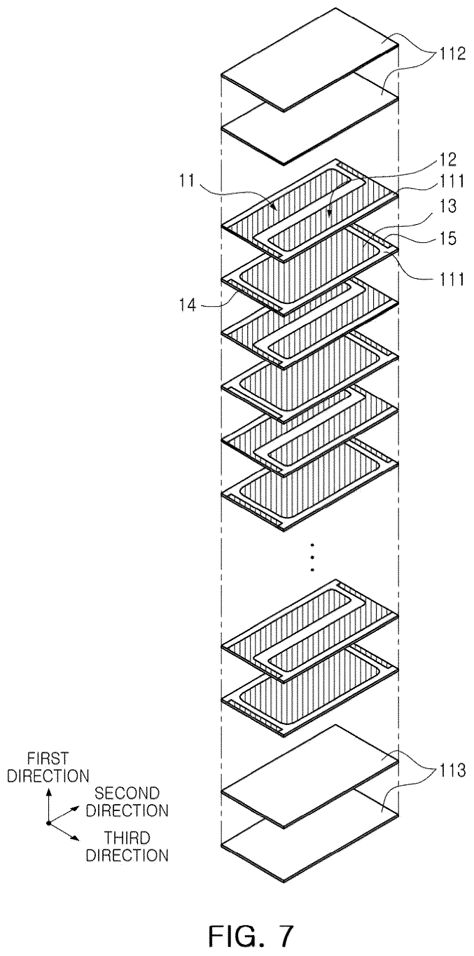

FIG. 7 schematically illustrates an exploded perspective view of a body according to some embodiments of the present disclosure.

Hereinafter, a multilayer electronic component according to an example embodiment of the present disclosure and another example embodiment of the present disclosure will be described in detail with reference to FIGS. 1 to 7. Additionally, a multilayer ceramic capacitor (hereinafter referred to as “MLCC”) is described as an example of a multilayer electronic component, but the present disclosure is not limited thereto, and the multilayer electronic component of the present disclosure may also be applied to various multilayer electronic components using ceramic materials, such as inductors, piezoelectric elements, varistors, or thermistors.

Before describing a multilayer electronic component according to an example embodiment of the present disclosure and a multilayer electronic component according to another example embodiment of the present disclosure, the components commonly included in the multilayer electronic component according to an example embodiment of the present disclosure and the multilayer electronic component according to another example embodiment of the present disclosure will be described.

A multilayer electronic component 100 according to some example embodiments of the present disclosure and a multilayer electronic component 100 according to another embodiment of the present disclosure may include a body 110: including a dielectric layer 111; an internal electrode layer 121 and a floating electrode layer 122 alternately disposed in the first direction with the dielectric layer interposed therebetween; first and second surfaces 1 and 2 opposing each other in the first direction; the third and fourth surfaces 3 and 4 connected to the first and second surfaces and opposing each other in the second direction; fifth and sixth surfaces 5 and 6 connected to the first to fourth surfaces and opposing each other in the third direction; external electrodes 130 and 140 disposed on the third and fourth surfaces, respectively.

The body 110 may include a dielectric layer 111, and an internal electrode layer 121 and a floating electrode layer 122 alternately disposed in the first direction with the dielectric layer 111 interposed therebetween.

A specific shape of the body 110 is not particularly limited, but as illustrated, the body 110 may have a hexahedral shape or a shape similar thereto. Due to contraction of ceramic powder particles included in the body 110 during a sintering process, the body 110 may not have a hexahedral shape with entirely straight lines but may have a substantially hexahedral shape.

The body 110 may include the first and second surfaces 1 and 2 opposing each other in the first direction, the third and fourth surfaces 3 and 4 connected to the first and second surfaces 1 and 2 and opposing each other in the second direction, and fifth and sixth surfaces 5 and 6 connected to the first to fourth surfaces and opposing each other in the third direction.

In the present disclosure, the first direction may mean a direction in which the internal electrode layer 121 and the floating electrode layer 122 are disposed with the dielectric layer 111 interposed therebetween, that is, a stacking direction of the internal electrode layer 121, the floating electrode layer 122, and the dielectric layer 111. Meanwhile, the second direction may refer to a direction, perpendicular to the first direction, and the third direction may mean a direction, perpendicular to the first direction and the second direction simultaneously.

On the other hand, as a margin region in which the electrode pattern is not disposed overlaps on the dielectric layer 111, a step portion may occur due to a thickness of the internal electrode layer, and accordingly, a corner connecting the first surface 1 and the third to fifth surfaces and/or a corner connecting the second surface 2 and the third to fifth surfaces 3, 4 and 5 may have a shape contracted toward the center of the body 110 in the first direction based on the first surface or the second surface. Alternatively, due to contraction behavior during a sintering process of the body, a corner connecting the first surface 1 and the third to sixth surfaces 3, 4, 5 and 6 and/or a corner connecting the second surface 2 and the third to sixth surfaces 3, 4, 5 and 6 may have a shape contracted toward a first directional center of the body 110 based on the first surface or the second surface. Alternatively, in order to prevent a chipping defect, a corner connecting each surface of the body 110 may be rounded by performing a separate process, so that the corner connecting the first surface 1 and the third to sixth surfaces 3, 4, 5 and 6 and/or the corner connecting the second surface 2 and the third to sixth surfaces 3, 4, 5 and 6 may have a round shape.

The dielectric layers 111 forming the body 110 may be formed in plural, and in a state in which a plurality of dielectric layers 111 are sintered, boundaries between adjacent dielectric layers 111 may be integrated so as to be difficult to identify without using a scanning electron microscope (SEM). The number of stacked dielectric layers 111 is not particularly limited, and may be determined in consideration of the size of the multilayer electronic component. For example, 400 or more dielectric layers may be stacked to form a body.

The dielectric layer 111 may be formed by producing a ceramic slurry containing ceramic powder particles, an organic solvent and a binder, applying and drying the slurry on a carrier film to prepare a ceramic green sheet, and then sintering the ceramic green sheet. The ceramic powder particles are not particularly limited as long as sufficient electrostatic capacitance may be obtained therewith, and for example, barium titanate-based (BaTiO₃) powder particles may be used as the ceramic powder particles. For more specific examples, the ceramic powder particles may include one or more selected from the group consisting of BaTiO₃, (Ba₁₋ₓCaₓ)TiO₃ (0<x<1), Ba(Ti_{1-y}Ca_{y})O₃ (0<Y<1), (Ba₁₋ₓCaₓ) (Ti_{1-y}Zr_{y})O₃ (0<x<1, 0<y<1), and Ba(Ti_{1-y}Zr_{y})O₃ (0<y<1).

On the other hand, when barium titanate (BaTiO₃)-based powder particles are used as a raw material for forming the dielectric layer 111, the dielectric layer 111 after sintering may include Ba and Ti.

An average thickness of the dielectric layer 111 is not particularly limited.

In order to implement miniaturization and high capacitance of the multilayer electronic component 100, an average thickness td of the dielectric layer 111 may be 0.35 μm or less, and in order to improve reliability of the multilayer electronic component 100 under high temperature and high voltage, an average thickness of the dielectric layer 111 may be 20 μm or more.

An average thickness of the dielectric layer 111 may be measured by scanning an image of the third and first directional cross-sections (L-T cross-sections) of the body 110 with a scanning electron microscope (SEM).

For example, with respect to a total of five dielectric layers, two layers to an upper portion and two layers to a lower portion based on a first layer of the dielectric layer at a point at which a longitudinal center line of the body meets a thickness center line among the dielectric layers extracted from an image of a length and thickness direction (L-T) cross-section obtained by cutting a center of the body 110 in a width direction scanned by the scanning electron microscope (SEM), an average thickness of the dielectric layer 111 may be measured by setting, equal intervals, five points, that is, two points to the left and two points to the right, centering on the one reference point and then measuring thicknesses of each point, based on the point at which the longitudinal center line of the body meets the thickness center line thereof.

When a voltage is applied to the multilayer electronic component 100, deformation such as contraction and expansion of the multilayer electronic component 100 may occur due to an electrostriction phenomenon in a dielectric layer. The electrostriction phenomenon may be further intensified when a high voltage is applied to the multilayer electronic component 100 or when BaTiO₃ is used as a material for the dielectric layer.

On the other hand, when the voltage is applied to the multilayer electronic component 100, deformation may occur in which the multilayer electronic component 100 may be expanded in the first direction, and may be contracted in the second direction and the third direction. Additionally, the stress caused by the deformation of the multilayer electronic component 100 may be concentrated on a boundary between a region in which electrostatic capacitance is formed and a region in which the electrostatic capacitance is not formed, which may act as a cause of generating cracks in the multilayer electronic component 100.

Referring to FIG. 6A, the internal electrode layer 121 may include a first electrode pattern 11 connected to the third surface 3, and a second electrode pattern 12 spaced apart from the first electrode pattern 11 in the third direction and connected to the fourth surface 4.

Referring to FIGS. 6A and 4, the first electrode pattern 11 and the second electrode pattern 12 may be spaced apart from each other by a distance W1 in the third direction. The distance W1 by which the first electrode pattern 11 and the second electrode pattern 12 are spaced apart from each other in the third direction is not particularly limited, but when a ratio of the distance W1 between the first electrode pattern 11 and the second electrode pattern 12 in the third direction to a width of margin portions 114 and 115 is more than 2.8 and less than 1, the stress remaining in the body 110 may be minimized. In this case, the width of the margin portions 114 and 115 illustrated in FIG. 6A may refer to a third directional width of a region between both ends of the internal electrode layer 121 in the third direction and the fifth and sixth surfaces.

Referring to FIG. 6B, the floating electrode layer 122 may include a third electrode pattern 13 spaced apart from the third surface 3 and the fourth surface 4.

The electrostatic capacitance may be formed in a region in which the first electrode pattern 11 and the third electrode pattern 13 overlap each other in the first direction and a region in which the second electrode pattern 12 and the third electrode pattern 13 overlap each other in the first direction. Specifically, referring to FIG. 4, the region in which the first electrode pattern 11 and the third electrode pattern 13 overlap each other in the first direction may be referred to as a first capacitance formation portion Ac1, and a region in which the second electrode pattern 12 and the third electrode pattern 13 overlap each other in the first direction may be referred to as a second capacitance formation portion Ac2. The first capacitance formation portion Ac1 and the second capacitance formation portion Ac2 may be spaced apart from each other in the third direction, and the region in which the first capacitance formation portion Ac1 and the second capacitance formation portion Ac2 are spaced apart from each other in the third direction may include a region in which no capacitance is formed. This may be a result of the separation of the capacitance formation portion in the third direction by disposing the first electrode pattern 11 and the second electrode pattern 12 to be spaced apart from each other in the third direction.

On the other hand, this structure corresponds to a structure in which a plurality of capacitors are connected in series and again in parallel as a whole, which may obtain the effect of distributing the voltage, thereby alleviating the electrostriction phenomenon of the multilayer electronic component.

Referring to FIG. 7, the body 110 may be formed by repeatedly stacking an internal electrode layer and a floating electrode layer in the first direction with a dielectric layer 111 interposed therebetween. Cover portions 112 and 113 may be disposed on first directional upper and lower surfaces in a region in which the internal electrode layer and the floating electrode layer are repeatedly stacked in the first direction with a dielectric layer 111 interposed therebetween.

Materials forming the first electrode pattern, the second electrode pattern, and the third electrode patterns 11, 12 and 13 are not particularly limited, and materials having excellent electrical conductivity may be used. For example, the first electrode pattern, the second electrode pattern and the third electrode patterns 11, 12 and 13 may include at least one selected from the group consisting of nickel (Ni), copper (Cu), palladium (Pd), silver (Ag), gold (Au), platinum (Pt), tin (Sn), tungsten (W), titanium (Ti), and alloys thereof.

The first electrode pattern, the second electrode pattern, and the third electrode patterns 11, 12 and 13 may be formed by printing a conductive paste on a ceramic green sheet, and the printing method may be a screen printing method or a gravure printing method, but the present disclosure is not limited thereto.

An average thickness of the internal electrode layer is not particularly limited.

In order to implement miniaturization and high capacitance of the multilayer electronic component 100, the average thickness of the internal electrode layer may be 0.35 μm or less, and in order to improve reliability under high temperature and high voltage of the multilayer electronic component 100, the average thickness of the internal electrode layer may be 3 μm or more.

A method of measuring the average thickness of the internal electrode layer is not particularly limited. For example, with respect to a total of five internal electrode layers, two layers to an upper portion and two layers to a lower portion based on a first layer of the internal electrode layer at a point at which a center line of each of the capacitance formation portions Ac1 and Ac2 in the longitudinal direction meets a center line thereof in the thickness direction among the internal electrode layers extracted from an image of a width and thickness direction (W-T) cross-section obtained by cutting a center of the body 110 in the longitudinal direction scanned by the scanning electron microscope (SEM), an average thickness of the internal electrode layer may be measured by setting, as equal intervals, five points, that is, two points to the left and two points to the right, centering on the one reference point and then measuring thicknesses of each point, based on the point at which the center line of each of the capacitance formation portions Ac1 and Ac2 in the longitudinal direction meets the center line thereof in the thickness direction.

Referring to FIGS. 2 to 4, the body 110 may include cover portions 112 and 113 disposed in an upper portion and a lower portion the first capacitance formation portion Ac1 and the second capacitance formation portion Ac2 in the first direction.

The cover portions 112 and 113 may be formed by stacking a single dielectric layer or two or more dielectric layers on upper and lower surfaces of the first capacitance formation portion Ac1 and the second capacitance formation portion Ac2 in a thickness direction (the first direction), respectively, and may basically serve to prevent damage to the internal electrode due to physical or chemical stress.

The cover portions 112 and 113 may not include an internal electrode and may include a dielectric layer 111 and a dielectric material. That is, the cover portions 112 and 113 may include a ceramic material, for example, a barium titanate (BaTiO₃)-based ceramic material.

Meanwhile, the thicknesses of the cover portions 112 and 113 need not be particularly limited. For example, an average thickness of the cover portions 112 and 113 may be 10 to 300 μm. The average thickness of the cover portions 112 and 113 may refer to a first directional size, and may be a value obtained by averaging the first directional sizes of the cover portions 112 and 113 measured at five points equally spaced apart from each other in the upper portion or the lower portion of the first capacitance formation portion RA1, the second capacitance formation portion RA2 and a capacitance non-formation portion RC.

The margin portions 114 and 115 may be disposed on side surfaces of the first capacitance formation portion Ac1 and the second capacitance formation portion Ac2.

Referring to FIG. 4, the margin portions 114 and 115 may be disposed on both end surfaces in the width direction of a ceramic body 110.

As illustrated in FIGS. 3, 4, 5A and 5B, the margin portions 114 and 115 may refer to a region between both ends of the internal electrode layer 121 or the floating electrode layer 122 in the third direction and a boundary surface of the body 110, in a cross-section obtained by cutting the body 110 in the width-thickness (W-T) direction.

The margin portions 114 and 115 may basically serve to prevent damage to the internal electrode due to physical or chemical stress.

The margin portions 114 and 115 may be formed by applying a conductive paste and forming first to third electrode patterns except for a region in which a margin portion is to be formed on the ceramic green sheet.

Additionally, in order to suppress a step portion, the dielectric layer 111, the internal electrode layer 121, and the floating electrode layer 122 may be stacked, and then, the internal electrode layer 121 and the floating electrode layer 122 may be cut to be exposed to the fifth and sixth surfaces 5 and 6 of the body, and a single dielectric layer or two or more dielectric layers may be stacked in the third direction (width direction), thus forming the margin portions 114 and 115.

Meanwhile, the widths of the margin portions 114 and 115 need not be particularly limited. For example, the widths of the margin portions 114 and 115 may be 5 to 300μm.

An average width of the margin portions 114 and 115 may refer to an average third directional size of a region in which the internal electrode is spaced apart from the fifth surface and an average third direction size of the region in which the internal electrode is spaced apart from the sixth surface, and may be a value obtained by averaging third directional sizes of the margin portions 114 and 115 measured at five points equally spaced apart from each other in side surfaces of the first capacitance formation portion Ac1 and the second capacitance formation portion Ac2.

The external electrodes 130 and 140 may be disposed on the third and fourth surfaces 3 and 4 of the body 110.

The external electrodes 130 and 140 may include first and second external electrodes 130 and 140 disposed on the third and fourth surfaces 3 and 4 of the body 110, respectively, and connected to the first and second electrode patterns 121 and 122, respectively. Specifically, the first external electrode 130 may be disposed on the third surface 3 and connected to the first electrode pattern 11, and the second external electrode 140 may be disposed on the fourth surface 4 and connected to the second electrode pattern 12.

Although an example embodiment of the present disclosure describes a structure in which the multilayer electronic component 100 has two external electrodes 130 and 140, but the number or shape of the external electrodes 130 and 140 may be changed according to the shape or other purpose of the internal electrode layer.

On the other hand, the external electrodes 130 and 140 may be formed of any material as long as they have electrical conductivity such as metal, and specific materials can be determined in consideration of electrical properties, structural stability, or the like, and the external electrodes 130 and 140 may further have a multilayer structure.

For example, the external electrodes 130 and 140 may include an electrode layer disposed on the body 110 and a plating layer formed on the electrode layer.

For a more specific example of the electrode layer, the electrode layer may be a sintered electrode including a conductive metal and glass, or a resin-based electrode including a conductive metal and a resin.

Furthermore, the electrode layer may have a form in which a plastic electrode and a resin-based electrode are sequentially formed on a body. Furthermore, the electrode layer may be formed by transferring a sheet including the conductive metal onto a body, or may be formed by transferring a sheet including the conductive metal onto the sintered electrode. Additionally, the electrode layer may be formed as a plating layer, or may be a layer formed by using a deposition method such as a sputtering method, an atomic layer deposition (ALD), or the like.

A conductive metal included in the external electrode layer may include a material having excellent electrical conductivity, and is not particularly limited. For example, the conductive metal may include one or more of nickel (Ni), copper (Cu), and their alloys.

The plating layer serve to improve the mounting characteristics. The type of the plating layer is not particularly limited, and may be a plating layer including one or more selected from the group consisting of Ni, Sn, Pd, and alloys thereof, and may be formed of a plurality of layers.

For a more specific example of the plating layer, the plating layer may include a Ni plating layer or a Sn plating layer, and may be a form in which the Ni plating layer and the Sn plating layer are sequentially formed on the external electrode layer, and may be a form in which the Sn plating layer, the Ni plating layer and the Sn plating layer are sequentially formed. Additionally, the plating layer may include a plurality of Ni plating layers and/or a plurality of Sn plating layers. Additionally, the plating layer may be a form in which the Ni plating layer and the Pd plating layer are sequentially formed on the external electrode layer.

A size of the multilayer electronic component 100 does not need to be particularly limited. Since it is advantageous in miniaturization and high capacitance according to the present disclosure, the multilayer electronic component 100 may be applied to a size of small IT products, and since high reliability may be secured in various environments, the multilayer electronic component 100 may be applied to a size of automotive electrical products requiring high reliability.

Referring to FIG. 5A, a multilayer electronic component according to Comparative Example includes an internal electrode layer including a first pattern 11′ and a second pattern 12′ spaced apart from each other in the second direction and not spaced apart from each other in the third direction, and a floating electrode layer 13′. Meanwhile, in FIG. 5A, the illustration of the dielectric layer disposed between the internal electrode layer and the floating electrode layer is omitted.

In the case of the multilayer electronic component according to Comparative Example, when a voltage is applied, stress may be concentrated on corners in which the internal electrode patterns having different polarities overlap each other, and a region in which this stress is concentrated is indicated as P′ in FIG. 5A.

When a voltage is applied to the multilayer electronic component according to Comparative Example, an electric field is formed in the first direction in a region in which the first pattern 11′ and the floating electrode layer overlap each other in the first direction, and an electric field is formed in the first direction in a region in which the second pattern 12′ and the floating electrode layer 13′ overlap each other in the first direction. Accordingly, stress concentration region P′ may be formed by concentrating on a boundary surface between the capacitance formation portion and the margin portion and a boundary surface between the capacitance formation portion and the capacitance non-formation portion.

Referring to FIG. 5B, the multilayer electronic component according to Inventive Example includes an internal electrode layer including a first electrode pattern 11 and a second electrode pattern 12 spaced apart in the third direction, and a floating electrode layer 122. Meanwhile, in FIG. 5B, the illustration of the dielectric layer disposed between the internal electrode layer and the floating electrode layer is omitted.

In FIG. 5B, a stress concentration region is indicated as P. Referring to FIG. 5B, the distribution of the stress concentration region P may be confirmed to be different from the distribution of the stress concentration area P′ of FIG. 5A.

It may be expected that the difference in the stress distribution is due to the fact that the first and second electrode patterns 11′ and 12′ of the internal electrode layer of the multilayer electronic component according to Comparative Example are spaced apart from each other only in the second direction, while the first and second electrode patterns 11′ and 12′ of the internal electrode layer of the multilayer electronic component according to Inventive Example are spaced apart from each other in the third direction.

Meanwhile, the multilayer electronic component according to an example embodiment of the present disclosure and the multilayer electronic component according to another example embodiment of the present disclosure may offset the stress acting on the stress concentration region P illustrated in FIG. 5B by allowing an electric field formed between the internal electrode layer 121 and the floating electrode layer 122 in the first direction to also be formed in the second or third direction.

Specifically, referring to FIG. 6B, the floating electrode layer 122 of the multilayer electronic component 100 according to an example embodiment of the present disclosure may include a third electrode pattern 13 spaced apart from the third surface 3 and the fourth surface 4, a fourth electrode pattern 14 spaced apart from the third electrode pattern and connected to the third surface 3, and a fifth electrode pattern 15 spaced apart from the third electrode pattern 13 and connected to the fourth surface 4. When the floating electrode layer 122 includes the

third electrode pattern 13 spaced apart from the third surface 3 and the fourth surface 4, the fourth electrode pattern 14 spaced apart from the third electrode pattern 13 and connected to the third surface 3, and the fifth electrode pattern 15 spaced apart from the third electrode pattern 13 and connected to the fourth surface 4, an electric field of a second directional component or a third directional component may be formed between the third electrode pattern 13 and the fourth electrode pattern 14 and between the third electrode pattern 13 and the fifth electrode pattern 15.

Accordingly, as compared to a conventional case in which the floating electrode layer 122 includes only the third electrode pattern 13 apart from the third surface 3 and the fourth surface 4 to concentrate tensile stress in the first direction and concentrate compressive stress in the second and third directions, since the compressive stress may be generated in the first direction and the tensile stress may be generated in the second and third directions, the stress acting on the stress concentration region P illustrated in FIG. 5B may be offset, thereby improving the reliability, including the BDV characteristics, of the multilayer electronic component 100.

In some example embodiments, the first electrode pattern 11 may be spaced apart from the fourth surface 4, and the second electrode pattern 12 may be spaced apart from the third surface 3. Accordingly, the first electrode pattern 11 and the second electrode pattern 12 may have different polarities.

In some example embodiments, the first electrode pattern 11 and the second electrode pattern 12 may be spaced apart from the fifth surface 5 and the sixth surface 6, and the third electrode pattern 13, the fourth electrode pattern 14, and the fifth electrode pattern 15 may be spaced apart from the fifth surface 5 and the sixth surface 6. Accordingly, the internal electrode layer 121 and the floating electrode layer 122 may not be exposed to the outside of the body (110), thereby improving the moisture resistance reliability of the multilayer electronic component 100.

In some example embodiments, the first electrode pattern 11 may include a first connection portion 11b in contact with the external electrode 130, and a first body portion 11a that extends in the second direction from the first connection portion 11b but is longer in the second direction and narrower in the third direction than the first connection portion 11b, and the second electrode pattern 12 may include a second connection portion 12b in contact with the external electrode 140, and a second body portion 12a that extends in the second direction from the second connection portion 12b but is longer in the second direction and narrower in the third direction than the second connection portion 12b.

The first connection portion 11b and the second connection portion 12b may refer to regions in contact with the external electrodes 130 and 140, respectively. Meanwhile, the first connection portion 11b and the second connection portion 12b may not overlap the third electrode pattern 13 in the first direction.

At least a portion of the first body portion 11a and at least a portion of the second body portion 12a may overlap a portion of the third electrode pattern 13 in the first direction, thereby forming electrostatic capacitance.

Meanwhile, the first body portion 11a extends in the second direction from the first connection portion 11b, but has a longer length in the second direction and a narrower width in the third direction than the first connection portion 11b, and the second body portion 12a extends in the second direction from the second connection portion 12b, but has a longer length in the second direction and a narrower width in the third direction than the second connection portion 12b, so that the electric field of the second directional component or the third directional component may be formed between the first body portion 11a and the second connection portion 12b and between the second body portion 12a and the first connection portion 11b.

Accordingly, as compared to a conventional case in which the internal electrode layer 121 includes the first electrode pattern 11 spaced apart in the second direction and connected to the third surface 3 and the second electrode pattern 12 connected to the fourth surface and a length and a width of the body portion and the connection portion are substantially constant, the stress applied to the stress concentration region may be offset, thereby improving the reliability, including the BDV characteristics, of the multilayer electronic component 100.

On the other hand, in a case in which the floating electrode layer 122 includes the third electrode pattern 13 spaced apart from the third surface 3 and the fourth surface 4, the fourth electrode pattern 14 spaced apart from the third electrode pattern and connected to the third surface 3 and the fifth electrode pattern 15 spaced apart from the third electrode pattern 13 and connected to the fourth surface 4, the first electrode pattern 11 includes the first connection portion 11b in contact with the external electrode 130 and the first body portion 11a that extends in the second direction from the first connection portion 11b but is longer in the second direction and narrower in the third direction than the first connection portion 11b, and the second electrode pattern 12 includes the second connection portion 12b in contact with the external electrode 140 and the second body portion 12a that extends from the second connection portion 12b in the second direction and is longer in the second direction and narrower in the third direction than the second connection portion 12b, the effect of offsetting stress in each layer of the internal electrode layer 121 and the floating electrode layer 122 may be obtained, so that the reliability improvement effect including the BDV characteristics of the multilayer electronic component 100 according to the present disclosure may be more remarkable.

Meanwhile, the first body portion 11a may be spaced apart from the second connection portion 12b in the second direction, and the second body portion 12a may be spaced apart from the first connection portion 11b in the second direction. Accordingly, the first electrode pattern 11 and the second electrode pattern 12 may also be spaced apart from each other in the second direction. In this case, when a second directional distance by which the first body portion and the fourth surface are spaced apart from each other is referred to as LM1, a second directional distance by which the first body portion and the second connection portion are spaced apart from each other is referred to as L1, a second directional distance by which the second body portion and the third surface are spaced apart from each other is referred to as LM2, and a second directional distance by which the second body portion and the first connection portion are spaced apart from each other is referred to as L2, if L1/LM1 is less than ⅛, or if L2/LM2 is less than ⅛, a short circuit may occur between the first electrode pattern 11 and the second electrode pattern 12, and if L1/LM1 is more than ⅓, or if L2/LM2 is more than ⅓, the bonding strength between the first connection portion 11b and the second connection portion 12b and the external electrodes 130 and 140 may be weakened. Accordingly, in an example embodiment, L1/LM1 may satisfy ⅛ or more and ⅓ or less, and L2/LM2 may satisfy ⅛ or more and ⅓ or less, and thus, a short circuit between the first electrode pattern 11 and the second electrode pattern 12 may be prevented and sufficient bonding strength between the connection portions 11b and 12b and the external electrodes 130 and 140 may be secured.

A method of measuring each of the second directional distance LM1 by which the first body portion and the fourth surface are spaced apart from each other, the second directional distance L1 by which the first body portion and the second connection portion are spaced apart from each other, the second directional distance LM2 by which the second body portion and the third surface are spaced apart from each other, and the second directional distance L2 by which the second body portion and the first connection portion are spaced apart from each other is not particularly limited.

In the first and second directional cross-sections polished to a ¼ point of the multilayer electronic component in the third direction so that the first body portion 11a and the second connection portion 12b are simultaneously exposed, the L1 and LM1 may be an average value measured with a scanning electron microscope (SEM) or an optical microscope (OP), in two or more layers of internal electrode layers disposed in an upper portion in the first direction and two or more layers of internal electrode layers disposed in a lower portion in the first direction based on the first body portion 11a disposed in the center in the first direction.

In the first and second directional cross-sections polished to a ¾ portion of the multilayer electronic component in the third direction so that the second body portion 12a and the first connection portion 11b are simultaneously exposed, the L2 and LM2 may be an average value measured with the scanning electron microscope (SEM) or the optical microscope (OP), in two or more layers of internal electrode layers disposed in an upper portion in the first direction and two or more layers of internal electrode layers disposed in a lower portion in the first direction based on the second body portion 12a disposed in the center in the first direction.

In an example embodiment, the corners of the first and second body portions may have a round shape, and the corners of the third electrode pattern may have a round shape. Accordingly, the phenomenon in which stress is concentrated at a specific position of the electrode pattern may be alleviated. Accordingly, the reliability improvement effect, including the BDV characteristics, of the multilayer electronic component 100 according to an example embodiment of the present disclosure may be further improved.

In an example embodiment, the dielectric layer 111 may include Ba and Ti. When the dielectric layer 111 is formed of a paraelectric dielectric corresponding to EIA Class 1, even if a voltage is applied, the electrostriction phenomenon may occur slightly or may rarely occur, while when the dielectric layer 111 is formed of a ferroelectric dielectric corresponding to EIA Class 2, for example, when the dielectric layer 111 includes Ba and Ti, the deformation due to the electrostriction phenomenon may occur to a measurable extent, and this deformation may cause stress to be generated inside the multilayer electronic component 100.

Meanwhile, according to an example embodiment of the present disclosure, even when the dielectric layer 111 includes Ba and Ti, the stress applied to a region on which the stress is concentrated may be offset. That is, when the dielectric layer 111 includes Ba and Ti, the reliability improvement effect including the BDV characteristics according to an example embodiment of the present disclosure may be further improved.

Hereinafter, a multilayer electronic component 100 according to another example embodiment of the present disclosure will be described, but the description overlapping that of the multilayer electronic component 100 according to the above-described embodiment of the present disclosure will be omitted.

Various examples of the multilayer electronic component according to some example embodiments of the present disclosure may also be applied to the multilayer electronic component according to another example embodiments of the present disclosure to be described below.

A floating electrode layer 122 of the multilayer electronic component according to another example embodiments of the present disclosure may include a third electrode pattern 13 spaced apart from a third surface 3 and a fourth surface 4, a first electrode pattern 11 may include a first connection portion 11b in contact with an external electrode 130 and a first body portion 11a that extends in a second direction from the first connection portion 11b but is longer in the second direction and narrower in the third direction than the first connection portion 11b, and a second electrode pattern 12 may include a second connection portion 12b in contact with an external electrode 140 and a second body portion 12a that extends in a second direction from the second connection portion 12b but is longer in the second direction and narrower in the third direction than the second connection portion 12b.

The first connection portion 11b and the second connection portion 12b may refer to regions in contact with the external electrodes 130 and 140, respectively. Meanwhile, the first connection portion 11b and the second connection portion 12b may not overlap the third electrode pattern 13 in the first direction.

At least a portion of the first body portion 11a and at least a portion of the second body portion 12a may overlap a portion of the third electrode pattern 13 in the first direction, thereby forming electrostatic capacitance.

Meanwhile, the first body portion 11a may extend in the second direction from the first connection portion 11b but may be longer in the second direction and narrower in the third direction than the first connection portion 11b, and the second body portion 12a may extend in the second direction from the second connection portion 12b but may be longer in the second direction and narrower in the third direction than the second connection portion 12b, so that an electric field of a second directional component or a third directional component may be formed between the first body portion 11a and the second connection portion 12b and between the second body portion 12a and the first connection portion 11b.

Accordingly, as the conventional case in which the internal electrode layer 121 includes a first electrode pattern 11 separated in the second direction and connected to the third surface 3 and a second electrode pattern 12 connected to the fourth surface, and the length and width of the body portion and the connection portion are substantially constant, the stress applied to the stress concentration region may be offset, thereby improving the reliability, including the BDV characteristics, of the multilayer electronic component 100.

Although the example embodiments of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression “an example embodiment” used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including: a dielectric layer; an internal electrode layer and a floating electrode layer alternately arranged in a first direction with the dielectric layer interposed therebetween; a first surface and a second surface opposing each other in the first direction; a third surface and a fourth surface connected to the first surface and the second surface and opposing each other in a second direction; and a fifth surface and a sixth surface connected to the first surface to the fourth surface and opposing each other in a third direction; and
at least two external electrodes disposed on each of the third surface and the fourth surface,
wherein the internal electrode layer includes a first electrode pattern connected to the third surface, and a second electrode pattern spaced apart from the first electrode pattern in the third direction and connected to the fourth surface, and
the floating electrode layer includes a third electrode pattern spaced apart from the third surface and the fourth surface, a fourth electrode pattern spaced apart from the third electrode pattern and connected to the third surface, and a fifth electrode pattern spaced apart from the third electrode pattern and connected to the fourth surface.

2. The multilayer electronic component according to claim 1, wherein the first electrode pattern is spaced apart from the fourth surface, and the second electrode pattern is spaced apart from the third surface.

3. The multilayer electronic component according to claim 1, wherein the first electrode pattern, the second electrode pattern
the third electrode pattern, the fourth electrode pattern, and the fifth electrode pattern are spaced apart from the fifth surface and the sixth surface of the body.

4. The multilayer electronic component according to claim 1, wherein the first electrode pattern includes a first connection portion in contact with at least one of the external electrodes on the third surface, and a first body portion that extends from the first connection portion in the second direction and having a length in the second direction longer than the first connection portion a width in the third direction narrower than the first connection portion, and
the second electrode pattern includes a second connection portion in contact with the external electrode on the fourth surface, and a second body portion that extends from the second connection portion in the second direction and having a length in the second direction longer than the second connection portion and a width in the third direction narrower than the second connection portion.

5. The multilayer electronic component according to claim 4, wherein the first body portion is spaced apart from the second connection portion in the second direction, and the second body portion is spaced apart from the first connection portion in the second direction, and
when a second directional distance by which the first body portion and the fourth surface are spaced apart from each other is referred to as LM1 and a second directional distance by which the first body portion and the second connection portion are spaced apart from each other is referred to as L1, and
when a second directional distance by which the second body portion and the third surface are spaced apart from each other is referred to as LM2 and a second directional distance by which the second body portion and the first connection portion are spaced apart from each other is referred to as L2,
L1/LM1 satisfies ⅛ or more and ⅓ or less, and
L2/LM2 satisfies ⅛ or more and ⅓ or less.

6. The multilayer electronic component according to claim 4, wherein corners of the first and second body portions have a round shape, and
corners of the third electrode pattern have a round shape.

7. The multilayer electronic component according to claim 1, wherein the dielectric layer includes Ba and Ti.

8. The multilayer electronic component according to claim 1, wherein an average thickness of the dielectric layer is 20 μm or more.

9. A multilayer electronic component, comprising:
a body including: a dielectric layer; an internal electrode layer and a floating electrode layer alternately arranged in a first direction with the dielectric layer interposed therebetween; a first surface and a second surface opposing each other in the first direction; a third surface and a fourth surface connected to the first surface and the second surface and opposing each other in a second direction; and a fifth surface and a sixth surface connected to the first surface to the fourth surface and opposing each other in a third direction; and
at least two external electrodes respectively disposed on the third surface and the fourth surface,
wherein the internal electrode layer includes a first electrode pattern connected to the third surface, and a second electrode pattern spaced apart from the first electrode pattern in the third direction and connected to the fourth surface,
the floating electrode layer includes a third electrode pattern spaced apart from the third surface and the fourth surface,
the first electrode pattern includes a first connection portion in contact with one of the external electrodes on the third surface, and a first body portion that extends from the first connection portion in the second direction and having a length in the second direction longer than the first connection portion and a width in the third direction narrower than the first connection portion, and
the second electrode pattern includes a second connection portion in contact with one of the external electrodes on the fourth surface, and a second body portion that extends from the second connection portion in the second direction and having a length in the second direction longer than the second connection portion and a width in the third direction narrower than the second connection portion.

10. The multilayer electronic component according to claim 9, wherein the first electrode pattern is spaced apart from the fourth surface, and the second electrode pattern is spaced apart from the third surface.

11. The multilayer electronic component according to claim 9, wherein the first electrode pattern and the second electrode pattern are spaced apart from the fifth surface and the sixth surface, and
the third electrode pattern is spaced apart from the fifth surface and the sixth surface.

12. The multilayer electronic component according to claim 9, wherein the first body portion is spaced apart from the second connection portion in the second direction, and the second body portion is spaced apart from the first connection portion in the second direction, and
when a second directional distance by which the first body portion and the fourth surface are spaced apart from each other is referred to as LM1 and a second directional distance by which the first body portion and the second connection portion are spaced apart from each other is referred to as L1, and
when a second directional distance by which the second body portion and the third surface are spaced apart from each other is referred to as LM2 and a second directional distance by which the second body portion and the first connection portion are spaced apart from each other is referred to as L2,
L1/LM1 satisfies ⅛ or more and ⅓ or less, and
L2/LM2 satisfies ⅛ or more and ⅓ or less.

13. The multilayer electronic component according to claim 9, wherein corners s of the first and second body portions have a round shape, and
corners of the third electrode pattern have a round shape.

14. The multilayer electronic component according to claim 9, wherein the dielectric layer includes Ba and Ti.

15. The multilayer electronic component according to claim 9, wherein an average thickness of the dielectric layer is 20 μm or more.
